(19) United States
(12) Patent Application Publication
(10) Pub. No.: US 2007/0043584 A1
(43) Pub. Date: Feb. 22, 2007

(54) Electronic game and method of playing bingo

(76) Inventor: David B. Waters, Piedmont, SC (US)

Correspondence Address: MCNAIR LAW FIRM, P.A., P.O. BOX 10827, GREENVILLE, SC, 29603-0827, US

(21) Appl. No.: 11/494,298

(22) Filed: Jul. 27, 2006

Related U.S. Application Data
(60) Provisional application No. 60/703,047, filed on Jul. 27, 2005.

(51) Int. Cl. G06Q 99/00

(52) U.S. Cl. 705/1

(57) ABSTRACT

A server having a computer readable medium storing a set of bingo numbers and bingo ball information representing bingo numbers and a closing pattern representing a winning bingo pattern. Instructions stored in the medium for receiving player information, selecting bingo cards from bingo card information, selecting a first bingo numbers less than the quantity of bingo numbers needed to obtain the closing pattern, determining whether the player performs a first daub within a time period for determining which first selected bingo numbers match the bingo card numbers, selecting a second set of bingo numbers to complete the closing pattern, determining whether the player performs a second daub within a time period for determining which second selected bingo numbers match the bingo card numbers, and determining whether the first and second selected numbers match the bingo card numbers resulting in the closing pattern thereby ending the game.

### CROSS REFERENCE TO RELATED APPLICATION

This application claims priority on U.S. Provisional Application Ser. No. 60/703,047, filed Jul. 27, 2005, entitled An Electronic Amusement Game and Method of Playing Bingo.

### FIELD OF THE INVENTION

This invention is directed to an amusement game and more specifically a system and method of enhancing the play of Bingo.

### BACKGROUND OF THE INVENTION

The game of bingo is well-known. Traditionally, this game is played with a bingo card having printed numbers in a five-by-five matrix with B I N G O printed across the top of each of the five columns. The center of the matrix may be considered a FREE space and does not require a number to be called to cross out, or daub, the FREE location. When numbers are called, such as B-13, the number 13 would be marked, or daubed, to show that the called number exists in the column marked B on that Bingo card. The selection of called numbers is traditionally provided in the form of a finite number of bingo balls that are shuffled and randomly selected from a box, cage, or mixer. Bingo balls are selected and numbers are called until a bingo player has his or her bingo card daubed in a winning pattern. A winning pattern, represented by declaring BINGO, can be a row, column, each corner, an X-pattern, black-out pattern, or any other pattern. A black-out pattern represents the condition where all of the numbers on the card have been called and are daubed. Typically, multiple players play the same game and a winner is declared when the first player realizes a winning pattern.

With the advent of modern technology, particularly computers, bingo has matured into what has been referred to as a Class II game in the gaming field. With Class II games, prizes are generally rewarded from funds deposited by the bingo player to play the game. Further, it is advantageous that for each bingo game played, at least one prize winner should exist for each game. Further, it is advantageous to have intermediate prizes so that several prizes are awarded during play. Further, it is advantageous for a bingo game system to have a progressive prize system so that a winner can play an aggregated prize collection source.

The introduction of Class II gaming has also resulted in bingo players being able to realize the benefits and enjoyment of playing computer enhanced bingo. Particularly the use of high definition graphics allows for a more exciting and enjoyable play.

Accordingly, to provide the advantages described herein, it is an object of this invention to provide for a computer enhanced bingo game allowing multiple players to play against each other while insuring a winner.

It is another object of this invention to provide a computer enhanced bingo game having intermediate prizes and progressive prizes.

### DESCRIPTION OF THE DRAWINGS

FIG. 1 is a flowchart of the invention;

FIG. 2 is a continuation of the flowchart of FIG. 1;

FIG. 3 is a schematic of the screen of the invention;

FIG. 4 is a schematic of a network for use with the invention; and,

FIG. 5 is a schematic of the invention.

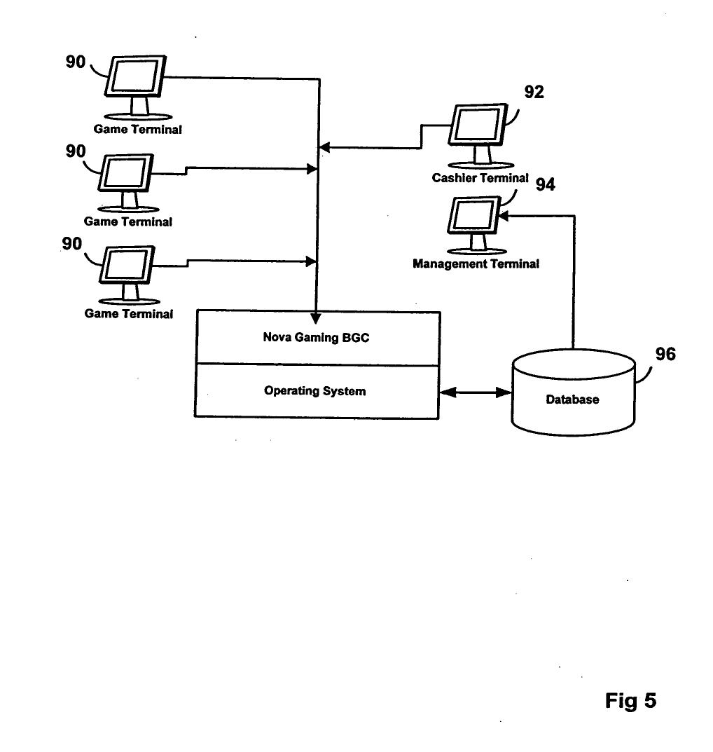

### DETAILED DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated by a set of computer readable instructions embodied in a computer readable medium that is designed to perform a specific task or tasks. Actual computer or executable code or computer readable code may be contained within one file or one storage medium but may also span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block or step of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The term media is used to include audio, video, animation or any other form audio or visual information. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

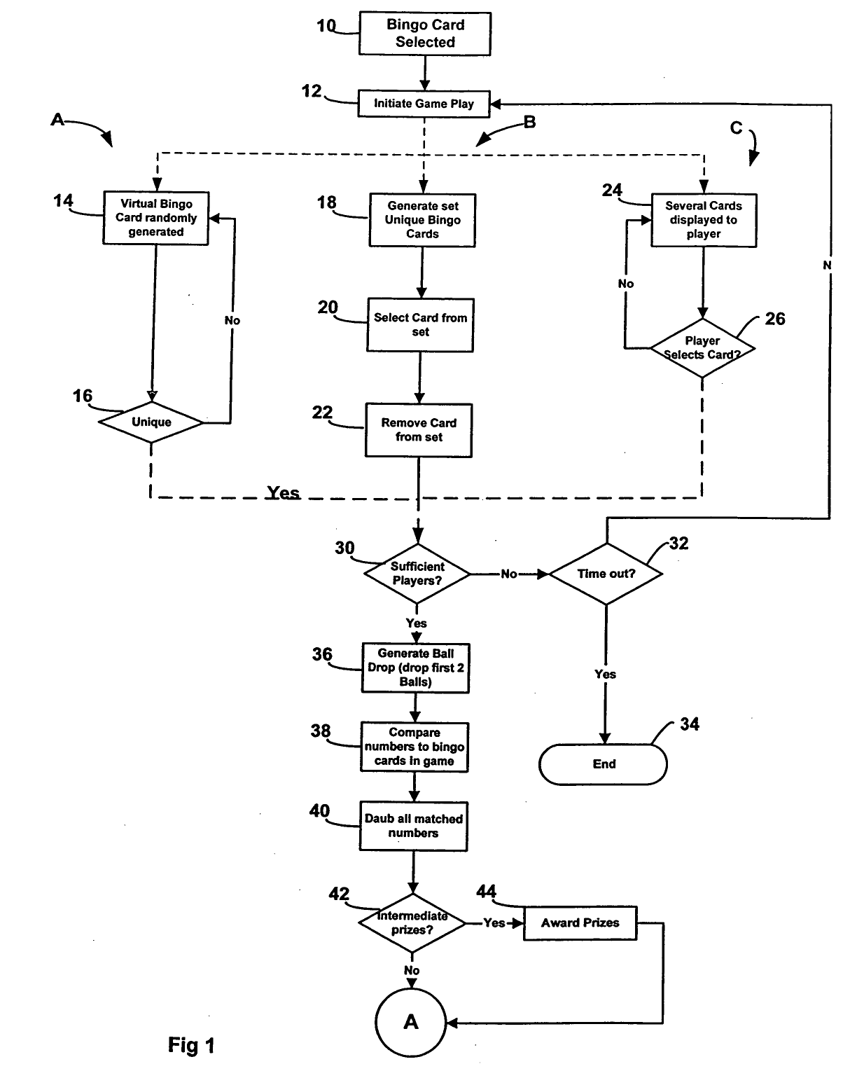

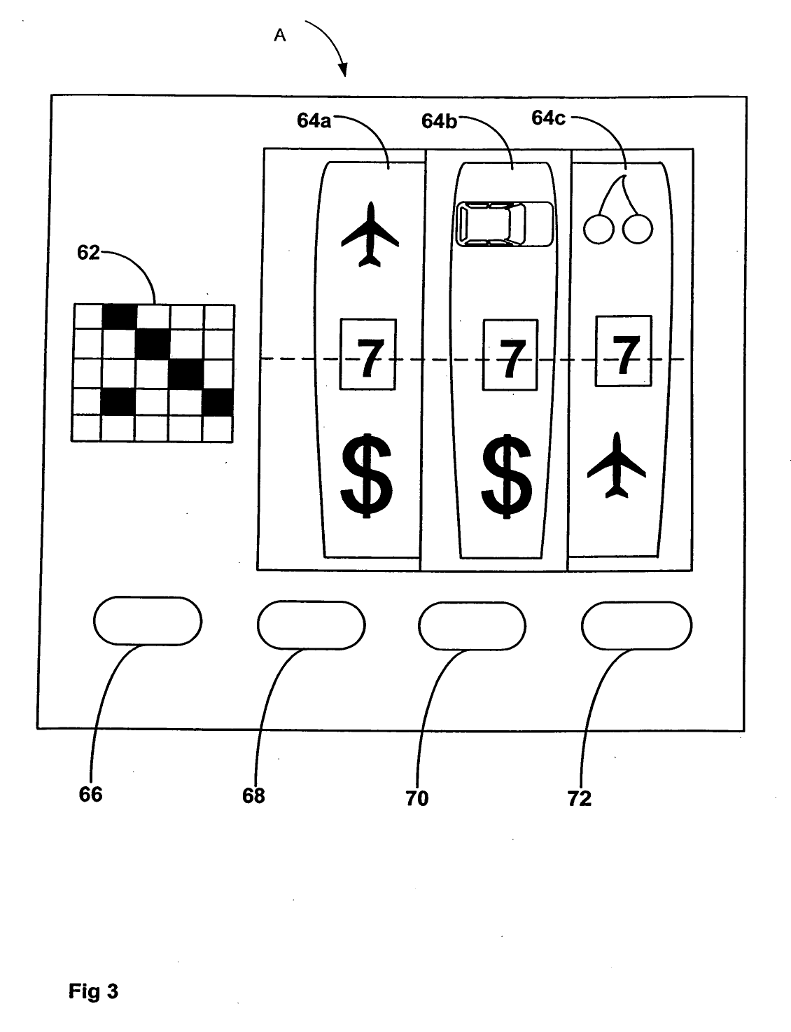

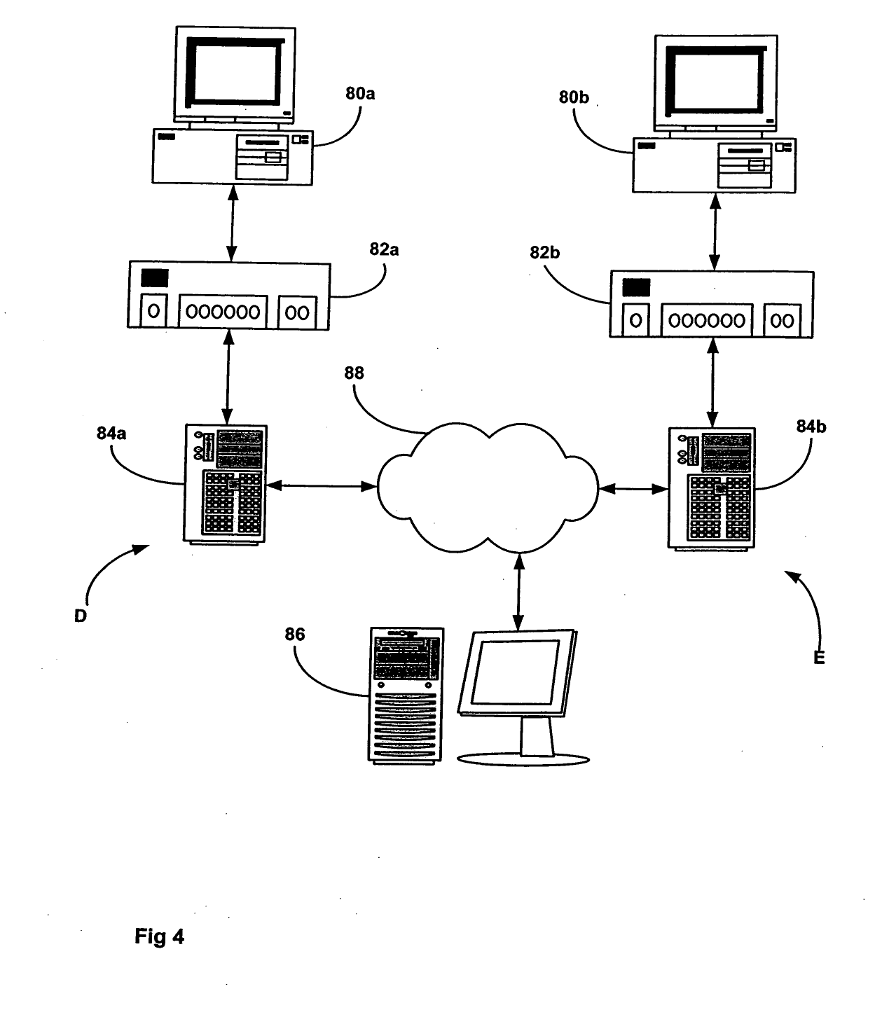

In one embodiment, all players, regardless of buy-in level, have the same opportunity to win interim prizes, although the prize amounts associated with these winning patterns could vary depending on the buy-in level. The server (84a of FIG. 3) verifies that there are at least two players on the system (step 30, FIG. 1A) and then waits for a period of time, typically, 2-10 seconds, for additional players to log in (step 32, FIG. 1A), based on the number of active terminals in play on the system. The invention is a linked bingo system played within a gaming facility and/or among gaming facilities. The system consists of four functional groups: player terminal (90 of FIG. 4), server (84a of FIG. 3), point-of-sale terminal (92 of FIG. 4), and management terminal (94 of FIG. 4).

The server is used to validate users on the point-of-sale and player terminals and run the management terminal software. All system and gaming information for the point-of-sale and player terminals is handled by the server. It controls all read/write to the database (96 of FIG. 4), all communications to all devices, all ball calls and all data logging. The management terminal is the interface for system and game configuration, reporting, and user security. The point-of-sale terminal is the financial interface that allows players to create new accounts, modify existing accounts, and cash out accounts. All player data is transmitted from the point-of-sale terminal to the server and stored in the database. The electronic player terminal is the game play interface with the player and is directly connected to the server. The invention is a linked electronic bingo system played within a gaming facility and optionally linked (88 of FIG. 3) to other gaming facilities. Players compete against one another within the facility and against all players in linked facilities.

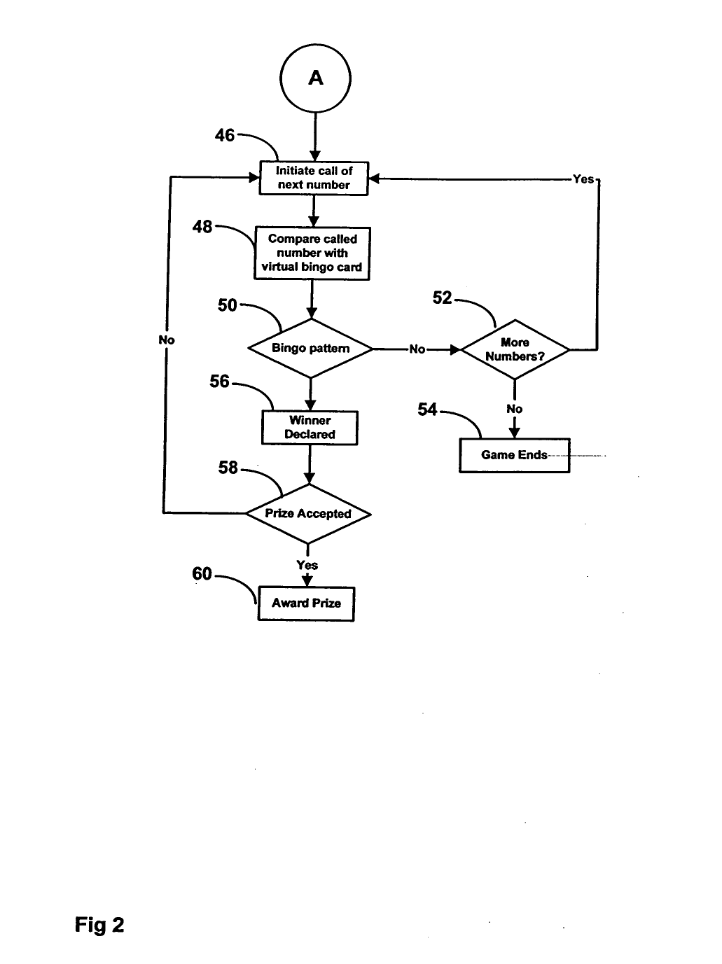

The player terminal will play a themed game with graphical displays. There are many themes, but all play on the invention and can operate as described. Prize tables may vary among game themes, but all game themes utilize a common bingo pattern set. The display for the game screen has several parts. In the center of the screen can be an animated reel set (64a-64c of FIG. 2), much like one you would see on a video line game. The left side of the screen shows a box with the player's bingo card (62 of FIG. 2), below the card is an empty space where the ball call for the game will appear once the game starts. The player's bingo card is a 5×5 grid, measuring 2.5″×2.5″ with the word “BINGO” atop the columns. The five columns of the bingo card are labeled B-I-N-G-O. Each column contains five numbers of a possible fifteen numbers (B 1-15, I 16-30, N 31-45, G 46-60, and O 61-75). The bingo card has a black background with white lettering in 26-point bold font. Below the card is a flash board where called balls are displayed. Below the flashboard is a display showing the closing (also game-ending o game-winning) pattern, which is “COVERALL” also known as black out. In the lower right corner, there is a box that displays the following information: Bet; Lines; Paid; and Credits representing credits bet, lines bet, credits paid, and credits available to play respectively. By touching this box a player can toggle between the number of credits and the cash value of those credits. The upper right corner of the display has a small graphic showing the denomination of credits for the game. The game can be played at various denominations. The denomination displayed is that which is currently being played. However, by touching this displayed denomination, a player can choose among the denominations available to play. Along the bottom row of the screen there are the following buttons: HELP; BET LINE (66 of FIG. 2); BET MAX (68 of FIG. 2); BET ONE (70 of FIG. 2); and DAUB (72 of FIG. 2). At any time by pressing the HELP button, a player will find an explanation for all aspects of playing the game. On the very bottom of the screen is a game status bar that displays assorted game related messages.

A player can also choose an alternate game play view. Below the flash board in which the ball call appears is a bar labeled “BINGO CARD VIEW.” By touching the “BINGO CARD VIEW” button, players can view a larger version of their bingo card instead of the video reels. To the right of the bingo card is a flash board where called balls are displayed. Below the flashboard is a display showing the game-closing pattern or game-winning pattern, which is “COVERALL” or “BLACK-OUT” in one embodiment. Beneath the ball call box appears the bar with the label “REELS VIEW.” By touching the “REELS VIEW” bar, the player can switch back to the reels view. Everything else on the screen remains the same.

When the game is not being played, the video screen cycles through the game play screen, the pay table, and a theme specific graphic that display “Insert Cash” or “Card to Play.” The player can bet different lines and multiple credits per line. The winning bingo patterns can be viewed via the PATTERNS button in the Help menu. The winning bingo patterns are categorized by number of lines bet and credits per line bet. The lines are highlighted in red as you choose to play them. Increasing the number of coins bet per line increases the possible winning prize. The player can select to bet up to nine lines and up to five credits per line by touching the BET MAX button. The player can instead also choose to bet one to nine lines using the BET LINE button and one to 5 credits per line using the BET ONE button. Players must bet the same number of credits for each line they play. The wager amount determines the payout amount, but in all cases every player competes using the same interim patterns and game-closing pattern and ball call.

Progressive prizes are offered for certain patterns, and are handled as any other interim prize. The progressive pattern must be successfully daubed in time within the first 24 numbers called (40 of FIG. 1A). There are always at least two releases of numbers and no prizes can be awarded on the first release. In the event that multiple players achieve the game-closing pattern associated with the progressive prize in the same game, the progressive prize is shared among the winning players.

To play the game, the player(s) open a new account at the point-of-sale terminal where the player is issued a card or at the game terminal when a player inserts money into the terminal. Player information associated with the player which can include player credits, player name, player password or personal identification number (PIN). If done at the point-of-sale terminal, the cashier enters the player's name for the new account. The player then enters his/her choice of PIN (4-8 digits in length) on the keypad and confirms the PIN by entering it a second time. The player gives the cashier the amount desired to be deposited into his/her account. The cashier enters this sum into the point-of-sale. A player club card is then printed by the card printer and given to the player.

If the player is using a player's card, the player inserts the card into the game terminal and inputs his/her pin. Once a player has logged in, their account balance will be displayed on the terminal. The player card is used for identification only; no money is actually transferred to the card. If a player adds cash to the player terminal after having inserted his/her card, credits will be added to the player's account.

In the invention, games are played in groups called sessions, which is considered to be any bingo game played using the same ordered pool of bingo numbers. All players enrolled in a common session will be competing for the intermediate winning prizes and game-ending patterns.

The game status bar prompts the player to “PLACE YOUR BET. HIT DAUB TO PLAY.” Bingo card information representing bingo cards are electronically stored in the server and distributed to the players on demand. By touching the bingo card displayed on the screen, the player can change the card with which they will play the game. The player then chooses to bet one to nine lines and one to five credits per line. After the player has selected the number of lines, number of credits per line and a bingo card to play, the player touches the DAUB or PLAY button. The server verifies that there are at least two players on the system for play to begin and that a player has enough credits in their account to cover the wager. An adaptive algorithm is used to allow more time for additional players to join based on the number of active game terminals. If there is only one player, the game status bar displays “WAITING FOR MORE PLAYERS. CURRENT WAGER IS . . . ” The game will let 30 seconds transpire before the game will abort with the message, “GAME ABORTED—NOT ENOUGH PLAYERS—TRY AGAIN.” appearing in the status bar. The player's account is not debited until the player has successfully joined a game.

When the server has determined a new game can begin, it starts drawing balls or bingo numbers for the game. There are always at least two releases of bingo numbers and no prizes can be awarded on the first release. In some cases, the player may cover more than one interim bingo pattern, and will be awarded the highest paying pattern only. If the player covers an interim pattern and the game-winning pattern, they will be paid for both the game winning pattern and the highest paying interim pattern. Once a new game begins, the server draws the first set of numbers (Release #1) which consists of two balls (36 of FIG. 1A). At the same time, the video reels on the player terminal screen begin to spin. In one embodiment, the smallest interim pattern is a three spot pattern, thus there can be no winners within the first release. Numbers are drawn from a set of 75 numbers (1-75). The server's random number generator determines the numbers. The numbers in the first release are determined when the game begins and are transmitted in real time from the server to all game terminals that have joined into that game and are displayed on the flash board of each game terminal in the order that the balls were drawn.

Once the bingo numbers have been displayed to the player, all players have the opportunity to daub the numbers within a predetermined period of time. The time period is programmable and is typically between 3 and 60 seconds. A typical setting is 10 seconds. The player is prompted to daub and must touch the screen or a mechanical button on the game terminal. If the player daubs in time, the daubed numbers are marked in red on their bingo card. If the player sleeps the release (by not daubing within the allotted time), the numbers are marked in dark gray. Only numbers successfully daubed are eligible for completing any pattern (interim or game winning). While the player still has the opportunity to daub numbers in subsequent releases, s/he cannot win any prizes that may have been awarded for patterns covered in a slept release. In one embodiment, after the first daub (or sleep), the server draws the next set of numbers (Release #2) which consists of exactly the number of balls required for the first potential player to achieve the game winning pattern. The numbers in this release are determined in real time and transmitted from the server to all game terminals that have joined into that game and are displayed on the flash board of each game terminal in the order that the balls were drawn. No additional bingo numbers are called unless the game winning player sleeps the bingo. In one embodiment, the minimum number of balls in the second release is 23 because the first release is two balls and it takes 25 to achieve the coverall bingo game winning pattern. The maximum number in the second release is 73 (this would only occur if there were multiple players all waiting on the 73^{rd} ball to coverall).

Once again the player will be required to daub (claim) by touching the screen or pressing a mechanical button within the allotted time (which can be 3-60 seconds, and is typically 10 seconds). If the player daubs within the predetermined period of time, the previously released numbers are daubed in red on their bingo card. Just as in the first daub, if the player sleeps the release, the numbers are marked in dark grey and only numbers successfully daubed are eligible for completing any pattern (interim or game winning). In the event that any player sleeps any bingo, the game will notify the player of the slept bingo and prize that was forfeited. If the player with the potential game winning pattern daubs the numbers within the time allotted, the game will be declared over, and the player will be awarded the game ending pattern prize plus any interim prizes (based on the first 24 balls called.) During the ball call (from initial release to final claiming daub), the alternate graphics display will be in motion and not displaying any results. Only after the game has been declared over will the animation stop and the bingo pattern result be displayed on the alternate graphics or bonus round alternate graphics.

All players, regardless of patterns achieved must daub to claim prizes (even if they don't have any winning patterns). If the first potential game winner fails to daub in time, additional balls will be released until the second potential winner has the game winning pattern. Again, all players must daub. Bingo numbers (or balls) are marked as above (Red=daubed in time, dark Gray=slept, Green=interim prizes), and the game continues in this fashion until there is only one possible winner remaining. The last potential winner MUST daub and has an indefinite period of time to daub. Any previous potential winner that sleeps when the game winning pattern is released from the game and may join another game. After the game is over, the highest winning pattern from the first 24 balls called is highlighted in green. The video reels stop spinning in symbol patterns matched to reflect the winning intermediate patterns matched on the bingo card. Every time the bingo card does not yield a winning pattern, the reels on the screen will spin to a non-winning combination. If the bingo card does display a winning pattern, a specific winning combination will be displayed on the reels. The status bar alerts the player if s/he has won bingo, and if so displays the monetary prizes won. Finally, the results of the game are transmitted to the Central Server. The player is then prompted once again to place their bet and hit ‘PLAY’ to play. If a player has won the game-ending pattern, which is COVERALL, s/he must daub their card in the allotted time or the player will forfeit the COVERALL prize.

When a player decides to stop playing, they must cash out. If a player inserted cash at the start of play, then the player presses the cash out button, a ticket is printed and dropped into the tray. The player then takes this ticket to the point-of-sale terminal where the cashier either enters the ticket number manually or scans the bar code on the ticket. The cashier then gives the player the appropriate amount of money. Once this ticket is cashed out it is invalid and future attempts to cash out the ticket will cause the following message: “Cash Out Ticket Failed: Ticket has already been cashed out.” If a player inserted a player's card for play, the player simply removes the card to end their session. The player may then take their card to the point-of-sale terminal to cash out or deposit money. Also they may simply keep their cards with remaining funds for future use. Cards remain active even if there isn't any credit remaining.

One embodiment of game play is as described above. Once the game is declared to be over, the system evaluates the numbers marked on the player's card and compares these to the list of common patterns that is played regardless of game theme or wager. This common pattern list is sorted from highest paying to lowest paying. The common pattern set is stored in the pattern table of the server database. The server begins at the top of the list and sees if the player achieved the given pattern. If a pattern match occurs, then the player will win the associated credit amount and the server exits the pattern match routines. If a match does not occur, then the server advances to the next pattern in the list and attempts a pattern match. This processing continues until the server finds a pattern match or the end of the pattern list is reached.

It can thus be said that the invention is played with cards in that the game is played with electronic bingo cards. These are bona fide cards in that they are readily visible, with dimensions of 2.5 inches by 2.5 inches, have high color contrast among the screen, the grid, and numbers within the grid, and are in an easy-to-read 26-point font. Part of the integral role that the bingo card plays in the case of the invention is that the bingo format of the game drives the spinning wheels display. That is, the numbers that are drawn and the patterns they form are what determine the patterns that the spinning wheels take. It is also important that the card is readily visible and that a player is able to discern what prize, if any, has been won by seeing the pattern on the bingo card.

All players, not just the winners, have the opportunity to daub when balls are released. A player covers when objects are drawn in that numbers are not stored on the game's computer. Instead, numbers are released sequentially and displayed in the order released and players all have the same opportunity to cover (or daub) immediately upon release of drawn balls. Players purchase their cards before numbers are generated. Once numbers are generated, players are cued to daub their cards. As in paper bingo, players cover in response to the numbers being drawn that correspond to numbers on their cards.

The first person who covers the pre-designated interim pattern wins the prize associated with that pattern, and the person who first daubs the game-ending pattern wins the prize given for ending the game. The invention allows that person to actually cover the pre-designated pattern.

In one embodiment, the number of balls released on the first ball draw must be some number less than the number of balls required for a player to achieve the win, that is, the game-ending pattern. The notion that the “first person to cover” wins is met by the invention provision that allows the game to continue if a player sleeps his game-winning bingo. Similarly, if a player fails to daub when he or she has one of the other pre-designated patterns that yield interim prizes, that player will forfeit the prize. Not allowing a player to sleep results in a game in which no one has to cover; the game would simply end, either with no one winning or with a person winning who has not had to cover. In the invention, if the winning player fails to daub the game-winning pattern, the player forfeits his prize and the game continues, with more numbers being revealed, until a player does cover the pre-designated game-winning pattern.

The player terminals on which the game may be played are linked in two ways. One, they are linked within the gaming operation so that players compete against each other in one location. Second, games may be linked through the central system, enabling players from different gaming operations or different reservations to compete against each other. The game may be played with as few as two (2) players. As noted above, the system waits anywhere from 2-10 seconds for additional players to log in, based on a mathematical algorithm that varies the enrollment period based on the number of active terminals in play on the system. With fewer terminals active, the algorithm lengthens the enrollment period to accommodate more players and thus broaden the participation.

In addition, participation among players, rather than against the machine, is encouraged by the successive ball releases and daubing requirements. By requiring players to participate and actually play the game, rather than simply start the game and complete it in one ball release, the invention broadens participation as well as requiring the player to play against other participants rather than just against the machine.

The invention can support multiple game themes without changing the operation of the game.

While a preferred embodiment of the invention has been described using specific terms, such description is for illustrative purposes only, and it is to be understood that changes and variations may be made without departing from the spirit or scope of the following claims.

What is claimed is:

1. A system for playing bingo comprising:
a server having a server computer readable medium;
a set of bingo numbers stored in said server computer readable medium;
a set of bingo ball information representing a plurality of bingo numbers stored in said server computer readable medium;
a closing pattern representing a winning bingo pattern stored in said server computer readable medium; and,
a set of server computer readable instructions stored in said server computer readable medium for receiving player information, selecting one of said bingo cards for the player from said set of bingo card information, selecting a first set of electronic bingo numbers, said first set having a quantity of bingo numbers less than the quantity of said bingo numbers needed to obtain said closing pattern, determining whether the player performs a first daub within a first predetermined period of time, determining which of said bingo numbers selected in said first set of bingo numbers match said bingo card numbers of said bingo card of the player if the player performs said first daub within said first predetermined period of time, selecting a second set of bingo numbers in sufficient quantity to achieve said closing pattern according to said bingo cards selected by the players, determining whether the player performs a second daub within a second predetermined period of time, determining which of said bingo numbers selected in said second set of bingo numbers match said bingo card numbers of said bingo card of the player if the player performs said second daub within said second predetermined period of time, and determining whether said bingo card numbers of said bingo card matched to said first and second set of bingo numbers result in said closing pattern thereby ending the game.

2. The system of claim 1 including:
an interim winning pattern representing an interim prize stored in said server computer readable medium; and
said server computer readable instructions include instructions for determining whether said bingo card numbers matched to said first and second set of bingo numbers result in said interim winning pattern.

3. The system of claim 2 including:
player information stored in said server computer readable medium;
credit information contained in said player information representing the number of credits associated with the player; and,
said server computer readable instructions include instructions for increasing the number of said credits associated with the player if said bingo card numbers of the player matched to said first and second set of bingo numbers result in said interim winning pattern.

4. The system of claim 2 including:
game line play information stored in said server computer readable medium representing the number of lines which the player can play for the game;
credit per line information stored in said server computer readable medium representing the number of credit per line that the player can play; and,
wherein said server computer readable instructions include instructions for receiving said game line play information selected the player, receiving said credits per line information selected by the player, and increasing the number of said credits associated with the player according to said line play information and said credits per line information selected by the player if said bingo card numbers matched to said first and second set of bingo numbers result in said interim winning pattern.

5. The system of claim 1 wherein said server computer readable instructions include instructions for selecting a third set of bingo numbers in sufficient number to achieve said closing pattern according to said bingo cards selected by the players if the player having said closing pattern fails to perform said first daub within said first predetermined period of time or fails to perform said second daub within said second predetermined period of time.

6. The system of claim 1 wherein said server computer readable instructions include instructions for receiving a change bingo card request from the player, selecting another said bingo card from said set of bingo card information according to said change bingo card request, and associating said selected bingo card with the player.

7. The system of claim 1 wherein said server computer readable instructions include instructions for determining whether there are at least two players to play the game prior to beginning the game and waiting for a predetermined period of time for additional players if there are not at least two players to play the game.

8. The system of claim 1 wherein said sever computer readable instructions include instructions for determining a predetermine period of time to wait for additional players according to the number of game terminals in communications with said server computer readable medium that are being used by different players, determining whether there are at least two players to play the game prior to beginning the game and waiting for said predetermined period of time for additional players if there are not at least two players to play the game.

9. The system of claim 1 including:
a game terminal having a display;
a game computer readable medium included with said game terminal in communications with said server computer readable medium; and,
a set of game terminal computer readable instructions stored in said game computer readable medium for receiving said set of bingo card information from said server computer readable medium, displaying said bingo card selected by the player on said display, receiving said first set of bingo numbers from said server computer readable medium, indicating on said displayed bingo card said bingo card numbers matching said bingo numbers in said first set of bingo numbers using a first indicator if the player performs said first daub within said first predetermined period of time, and indicating on said displayed bingo card said bingo card numbers matching said bingo numbers in said first set of bingo numbers using a second indicator if the player did not perform said first daub within said first predetermined period of time.

10. The system of claim 1 including:
an interim winning pattern representing an interim prize stored in said server computer readable medium;
a game terminal having a display;
a game computer readable medium included with said game terminal in communications with said server computer readable medium; and,
a set of game terminal computer readable instructions stored in said game computer readable medium for displaying a plurality of spinning reels on said display during game play and displaying stopped reels once the player is determined to have said interim winning pattern.

11. The system of claim 10 wherein said set of game terminal computer readable instructions include instructions for displaying stopped reels on said display only after it has been determined that the player has achieved said closing pattern.

12. The system of claim 1 including:
a point of sale terminal having a point of sale computer readable medium included with said point of sale terminal in communications with said server computer readable medium;
a player card printer in communications with said point of sale terminal;
a set of point of sale computer readable instructions stored in said point of sale computer readable medium for receiving player information having player credit information, transmitting said player information to said server computer readable medium, creating a player card according to said player information and using said player card printer; and,
said server computer readable instructions include instructions for creating a player account according to said player information.

13. The system of claim 1 including:
an interim winning pattern representing an interim prize stored in said server computer readable medium; and,
said set of server computer readable instructions for selecting a first set of bingo numbers including selecting said first set of bingo numbers having a quantity of bingo numbers that is less than the number of bingo numbers needed to obtain said interim winning pattern.

14. The system of claim 1 including:
a game terminal having a display;
a game computer readable medium included with said game terminal in communications with said server computer readable medium; and,
a set of game terminal computer readable instructions stored in said game computer readable medium for displaying a reel set on said display having spinning reels when the game is being played and stopped reels representing interim winning patterns, displaying said bingo card of the player, displaying a ball call area representing the balls which are drawn in said first and second set of bingo numbers, and displaying said closing pattern.

15. The system of claim 1 including:
a game terminal having a display;
a game computer readable medium included with said game terminal in communications with said server computer readable medium;
a card reader included within said game terminal and in communications with said game computer readable medium for receiving a player card having player information and;
a set of game terminal computer readable instructions stored in said game computer readable medium for receiving player information from said player card reader and transmitting said player information to said server computer readable medium.

16. The system of claim 1 including:
a plurality of interim winning patterns representing a plurality of interim prizes stored in said server computer readable medium; and,
said server computer readable instructions include instructions for determining whether said bingo card numbers matched to said first and second set of bingo numbers result in a plurality of said interim winning patterns and increasing credits associated with the player according to the highest paying interim winning pattern if bingo card numbers matching said first and second set of bingo numbers result in a plurality of interim winning patterns.

17. A system for playing bingo comprising:
a server having a server computer readable medium;
a set of bingo card information representing a plurality of bingo cards, each having a plurality of bingo card numbers, stored in said server computer readable medium;
a set of bingo numbers, stored in said server computer readable medium;
a closing pattern representing a winning bingo pattern stored in said server computer readable medium;
a set of server computer readable instructions stored in said computer readable medium for receiving player information, selecting a bingo card for the player from said set of bingo card information, selecting a first set of bingo numbers having a quantity of said bingo numbers less than the quantity of said bingo numbers needed to obtain said closing pattern, determining whether the player performs a first daub within a first predetermined period of time, determining which bingo numbers of said first set of bingo numbers match said bingo card numbers of said bingo card of the player if the player performs said first daub within said first predetermined period of time, selecting a second set of bingo numbers in sufficient number to achieve said closing pattern according to the bingo cards selected by the players, determining whether the player performs a second daub within a second predetermined period of time, determining which bingo numbers of said second set of bingo numbers match said bingo card numbers of said bingo card of the player if the player performs said second daub within said second predetermined period of time, and determining whether said bingo card numbers of said bingo card matching said first and second set of bingo numbers result in said closing pattern thereby ending the game;
a game terminal having a display;
a game computer readable medium included with said game terminal in communications with said server computer readable medium; and,
a set of game terminal computer readable instructions stored in said game computer readable medium for receiving said bingo card information from said server computer readable medium, and displaying said selected bingo card on said display.

18. The system of claim 17 including:
an interim winning pattern representing an interim prize stored in said server computer readable medium; and,
said server computer readable instructions include instructions for determining whether said bingo card numbers matching said first and second set of bingo numbers result in said interim winning pattern.

19. The system of claim 18 including:
player information stored in said server computer readable medium;
credit information contained in said player information representing the number of credits associated with the player; and,
said server computer readable instructions include instructions for increasing the credits of said player information if said bingo card numbers matching said first and second set of bingo numbers result in said interim winning pattern.

20. The system of claim 19 including:
game line play information stored in said server computer readable medium representing the number of lines which the player can play for the game;
credit per line information stored in said server computer readable medium representing the number of credits per line that the player can play; and,
wherein said server computer readable instructions include instructions for receiving game line play information selected by the player, receiving credits per line information selected by the player, and increasing credits of said player information according to said line play information and said credits per line information if said bingo card numbers matching said first and second set of bingo numbers result in said interim winning pattern.

21. The system of claim 17 wherein said server computer readable instructions include instructions for drawing a third set of bingo balls in sufficient numbers to achieve said closing pattern according to said bingo cards selected by the players if the player having said closing pattern fails to perform said first daub within said first predetermined period of time or fails to perform said second daub within said second predetermined period of time.

22. The system of claim 17 wherein:
said server computer readable instructions include instructions for receiving a change bingo card request from the player, selecting another said bingo card from said set of bingo card information according to said change bingo card request, and associating said selected bingo card with the player; and,
said game computer readable instructions include instructions for displaying said selected bingo card from said server computer readable medium and displaying said selected bingo card on said display.

23. The system of claim 17 wherein:
said server computer readable instructions include instructions for determining whether there are at least two players to play the game prior to beginning the game and waiting for a predetermined period of time for additional players if there are not at least two players to play the game; and,
said game computer readable instructions include instructions for displaying a message on said display representing that the game cannot begin until at least two players have joined the game.

24. The system of claim 17 wherein:
said sever computer readable instructions include instructions for determining a period of time to wait for additional players according to the number of game terminals in communications with said server computer readable medium that are being used by different players, determining whether there are at least two players to play the game prior to beginning the game and waiting for said period of time for additional players if there are not at least two players to play the game; and,
said game computer readable instructions include instructions for displaying a message on said display representing that the game cannot begin until at least two players have joined the game.

25. The system of claim 17 wherein said set of game terminal computer readable instructions include instructions for receiving said first set of bingo numbers from said server computer readable medium, indicating on said displayed bingo card aid bingo card numbers matching said bingo numbers in said first set of bingo numbers using a first indicator if the player performs said first daub within said first predetermined period of time, and indicating on said displayed bingo card said bingo card numbers matching said bingo numbers in said first set of bingo numbers using a second indicator if the player did not perform said first daub within said first predetermined period of time.

26. The system of claim 17 including:
an interim winning pattern representing an interim prize stored in said server computer readable medium; and,
said set of game terminal computer readable instructions include instructions for displaying a plurality of spinning reels on said display during game play and displaying stopped reels once the player is determined to have said interim winning pattern.

27. The system of claim 17 wherein said set of game terminal computer readable instructions include instructions for displaying stopped reels only after it has been determined that the player has achieved said closing pattern.

28. The system of claim 17 including:
a point of sale terminal having a point of sale computer readable medium included with said point of sale terminal in communications with said server computer readable medium;
a player card printer in communications with said point of sale terminal;
a set of point of sale computer readable instructions stored in said point of sale computer readable medium for receiving player information having player credit information, transmitting said player information to said server computer readable medium, creating a player card according to said player information and using said player card printer; and,
said server computer readable instructions include instructions for creating a player account according to said player information.

29. The system of claim 17 including:
an interim winning pattern representing an interim prize stored in said server computer readable medium; and,
said set of server computer readable instructions for selecting a first set of bingo numbers having a number of said bingo numbers less than the number of bingo numbers needed to obtain said interim winning pattern.

30. The system of claim 17 wherein said set of game terminal computer readable instructions include instructions for displaying a reel set on said display having spinning reels when the game is being played and stopped reels representing interim winning patterns, displaying said bingo card of the player, displaying a ball call area representing the bingo numbers which are selected in said first and second set of bingo numbers, and displaying said closing pattern.

31. The system of claim 17 including:
a card reader included within said game terminal and in communications with said game computer readable medium for receiving a player card having player information; and,
said set of game terminal computer readable instructions include instructions for receiving player information from said player card reader and transmitting said player information to said server computer readable medium.

32. The system of claim 17 including:
an interim winning pattern representing an interim prize stored in said server computer readable medium; and,
said server computer readable instructions include instructions for determining whether said bingo card numbers matching said first and second set of bingo numbers result in said interim winning pattern and increasing said credits in said credit information according to the highest paying interim winning pattern if said bingo card numbers matching said first and second set of bingo numbers result in a plurality of interim winning patterns.

33. A method for playing bingo comprising the steps of:
providing an electronic set of bingo cards each having a plurality of bingo card numbers;
providing an electronic set of bingo balls each having a bingo number;
determining a closing pattern representing a winning bingo pattern;
selecting an electronic bingo card for the player from said set of electronic bingo card information;
selecting a first set of electronic bingo balls having a number of balls less than the number of balls needed to obtain the closing pattern;
determining whether the player performs a first daub within a first predetermined period of time;
determining which bingo numbers of the first selected set of electronic bingo balls match the bingo card numbers of the player's bingo card if the player performs said first daub within said first predetermined period of time;
selecting a second set of electronic bingo balls in sufficient number to achieve a closing pattern;
determining whether the player performs a second daub within a second predetermined period of time;
determining which bingo numbers of the second selected set of electronic bingo balls match the bingo card numbers of the player's bingo card if the player performs the second daub within the second predetermined period of time; and,
determining whether the bingo card numbers of the player's bingo card matched to the first and second selected sets of electronic balls result in the closing pattern thereby ending the game.

34. The method of claim 33 including the steps of:
determining an interim winning pattern representing an interim prize; and
determining whether the bingo card numbers matched to the first and second selected sets of electronic bingo balls result in the interim winning pattern.

35. The method of claim 34 including the steps of:
providing player information having credit information representing the number of credits associated with the player; and,
increasing the credits of the credit information if the bingo card numbers matched to the first and second selected sets of electronic bingo balls result in the interim winning pattern.

36. The method of claim 34 including the steps of:
providing game line play information representing the number of lines which the player can play for the game;
providing credit per line information representing the number of credit per line that the player can play;
receiving game line play information selected by the player;
receiving credits per line information selected by the player; and,
increasing credits of the credit information according to the line play information and the credit per line information if the numbers of the bingo card matched to the first and second selected set of electronic bingo balls result in said interim winning pattern.

37. The method of claim 33 including the step of drawing a third set of electronic bingo balls having a sufficient number of electronic bingo balls to achieve the closing pattern according to the bingo cards selected by the players if the player having said closing pattern fails to perform the first daub within the first predetermined period of time or fails to perform the second daub within the second predetermined period of time.

38. The method of claim 33 including the steps of:
receiving a change bingo card request from the player selecting another electronic bingo card from the set of electronic bingo card information according to the change bingo card request; and,
associating the selected electronic bingo card with the player.

39. The method of claim 33 including the steps of:
determining whether there are at least two players to play the game prior to beginning the game; and,
waiting for a predetermined period of time for additional players if there are not at least two players to play the game.

40. The method of claim 33 including the steps of:
determining a predetermine period of time to wait for additional players according to the number of game terminals in communications with said server computer readable medium that are being used by different players; and,
waiting for said predetermined period of time for additional players if there are not at least two players to play the game.

41. The method of claim 33 including the steps of:
displaying the selected bingo card on a display;
indicating on the displayed bingo card the bingo card numbers matching the electronic bingo balls in the first selected set of electronic bingo balls using a first indicator if the player performs the first daub within the first predetermined period of time; and,
indicating on the displayed bingo card the bingo card numbers matching the electronic bingo balls in the first selected set of electronic bingo balls using a second indicator if the player did not perform the first daub within the first predetermined period of time.

42. The method of claim 33 including:
determining an interim winning pattern representing an interim prize;
displaying a plurality of spinning reels on a display during game play; and,
displaying stopped reels once the player is determined to have said interim winning pattern.

43. The method of claim 42 including the step of displaying stopped reels on the display only after it has been determined that the player has achieved the closing pattern.

44. The method of claim 33 including the steps of:
receiving player information having player credit information;
creating a player card according to the player information; and,
creating a player account according to the player information.

45. The method of claim 33 including the steps of:
determining an interim winning pattern representing an interim prize; and,
the step of selecting the first set of bingo numbers including the step of selecting the first set of electronic bingo balls having less bingo balls than the number of bingo balls needed to obtain the interim winning pattern.

46. The method of claim 33 including the steps of:
displaying a reel set on a display having spinning reels when the game is being played and stopped reels representing interim winning patterns;
displaying the bingo card of the player;
displaying a ball call area representing the electronic bingo balls which are selected in the first and second set of electronic bingo balls; and,
displaying the closing pattern.

47. The method of claim 44 including the steps of:
determining a plurality of interim winning patterns representing a plurality of interim prizes;
determining whether the bingo card numbers matched to the first and second selected set of electronic bingo balls result in a plurality of the interim winning patterns; and,
increasing credits in the player information according to the highest paying interim winning pattern if the bingo card numbers matching the first and second selected set of electronic bingo balls result in a plurality of interim winning patterns.
